(19) United States
(12) Patent Application Publication
(10) Pub. No.: US 2025/0312859 A1
(43) Pub. Date: Oct. 9, 2025

(54) MACHINE TOOL AND METHOD

(71) Applicant: KLINGELNBERG AG, Zürich (CH)

(72) Inventors: Robin Dirks, Wermelskirchen (DE); Nils Kusche, Hückeswagen (DE)

(21) Appl. No.: 19/098,319

(22) Filed: Apr. 2, 2025

(30) Foreign Application Priority Data
Apr. 5, 2024 (DE) 10 2024 109 586.5

(51) Int. Cl. B23F 23/12; G01B 5/20

(52) U.S. Cl. CPC B23F 23/1218; G01B 5/202

(57) ABSTRACT

A machine tool for the production of gearings, having a workpiece spindle, having a tool spindle and having a device for finding tooth spaces of a pre-toothed workpiece held on the workpiece spindle, wherein the device for finding tooth spaces has a mechanical resistance element for insertion into the tooth spaces of the pre-toothed workpiece.

### CROSS-REFERENCE TO RELATED APPLICATIONS

This application claims the benefit of German patent application no. 10 2024 109 586.5, filed on 5 Apr. 2024, the disclosure of which is incorporated herein by reference in its entirety.

### TECHNICAL FIELD

The present disclosure relates to a machine tool for the production of gearings, having a workpiece spindle, having a tool spindle and having a device for finding tooth spaces in a pre-toothed workpiece held on the workpiece spindle. The disclosure also relates to a method for using such a machine tool.

### BACKGROUND

In the soft machining of non-pre-toothed blanks, a gear cutting tool is used for milling into the solid material, wherein the usually rotationally symmetrical blank does not have any specifications regarding the position of the first tooth space to be produced before the first cut. Accordingly, the orientation or rotational position of the non-pre-toothed blank within the machine tool is irrelevant before the first cut. It is understood that other processes with a geometrically defined cutting edge, such as gear skiving or gear shaping, can also be used for soft machining in the manner described.

When soft machining pre-toothed blanks, the blanks already have recognizable teeth that have been produced by forging, for example. In this case, the first cut during soft machining cannot be milled into the solid material at will, but the predefined position of the teeth and gaps must be taken into account. For soft machining of pre-toothed blanks, it is therefore necessary to center the tool in order to align it centrally within the tooth spaces.

The centering process is well known from the hard fine machining of gears, such as gear grinding. With centering, the teeth and gaps of a usually soft-machined and hardened gear are detected before grinding in a clamped state on the workpiece spindle in order to determine their position within the machine tool. This can be carried out, for example, in a contactless manner using inductive or capacitive sensors or in a tactile manner using a measuring probe. The workpiece is then aligned relative to the tool and inserted into the gaps for machining.

Investigations by the applicant have shown that contactless sensors, which are used in machine tools for hard fine machining to find the teeth and gaps, are only suitable to a limited extent for finding the teeth and gaps of pre-toothed blanks that are fed to soft machining. The reason for this is the much coarser tolerances of these blanks fed to soft machining, which in some cases allow deviations that lie outside the measuring range of the known sensors used in machine tools for hard fine machining.

### SUMMARY

Against this background, the present disclosure is based on the technical problem of providing an improved machine tool and a method for using such a machine tool, which are particularly suitable for reliably finding gaps and/or teeth in pre-toothed blanks which are fed to soft machining.

The technical problem described above is solved with the features of the independent claims. Further designs of the disclosure result from the dependent claims and the following description.

According to the disclosure, a machine tool for the production of gearing is provided, having a workpiece spindle, having a tool spindle and having a device for finding tooth spaces in a pre-toothed workpiece held on the workpiece spindle. The machine tool is characterized in that the device for finding tooth spaces has a mechanical resistance element for insertion into the tooth spaces of the pre-toothed workpiece.

The mechanical resistance element can be successively brought into contact with neighboring teeth of the pre-toothed workpiece and thus provide measurable mechanical resistance to a movement of the pre-toothed workpiece. As soon as the mechanical resistance element comes into contact with a tooth flank of the pre-toothed workpiece, a corresponding rotational position or angular position of the workpiece spindle can be stored, for example.

For example, the mechanical resistance element can “rattle” through the tooth spaces of the pre-toothed workpiece, wherein the pre-toothed workpiece rotates while the mechanical resistance element is displaced from tooth mesh to tooth mesh, or slides along the rotating teeth from tooth space to tooth space.

The impacts of the contact between the tooth flanks and the mechanical resistance element can be measured and can be assigned to angular positions of the workpiece spindle. This allows the positions of the tooth flanks and thus also the tooth spaces to be determined.

In particular, the mechanical resistor element can be fed in.

In particular, the mechanical resistance element does not have a sensor, encoder or the like. In particular, the mechanical resistance of the resistance element in the tooth mesh is detected exclusively indirectly using existing operating resources of the machine tool, e.g. via power consumption of a drive of the workpiece spindle, vibration or acceleration sensors of the machine tool or the like. The mechanical resistance element can therefore be retrofitted to existing machine tools in a cost-effective manner in order to simplify the detection of gaps in pre-toothed workpieces.

The terms “pre-toothed workpieces” and “pre-toothed blanks” are used Synonymously in this text. The terms “gaps” and “tooth spaces” are used interchangeably in this text.

The mechanical resistance element can be elastically deformable.

The mechanical resistance element can be resiliently preloaded in a contact position.

The mechanical resistance element can be set up to engage in the tooth spaces as a result of rotation of the workpiece spindle and be displaced by teeth of the pre-toothed workpiece and jump from tooth space to tooth space or slide along the teeth into adjacent spaces.

The mechanical resistance element can have a plastic material or comprise a plastic material. The mechanical resistance element can have a metallic material or comprise a metallic material.

The mechanical resistance element can be a plate-shaped or rod-shaped component whose length is at least twice its respective width and thickness, in particular at least three times its respective width and thickness, and in particular at least four times its respective width and thickness.

The mechanical resistance element can be held on the tool spindle. The mechanical resistance element can be moved with the controlled machine axes assigned to the tool spindle.

The mechanical resistance element can be attached to a carrier assigned to the tool spindle.

In particular, the mechanical resistance element is held on the tool spindle at a distance from a tool holder of the tool spindle. Thus, both the gear cutting tool required for machining and the mechanical resistance element can be held on the tool spindle at the same time. In particular, the mechanical resistance element can be arranged adjacent to a tool holder of the tool spindle and/or a gear cutting tool held on it.

The mechanical resistance element can have a longitudinal extension that is oriented parallel to an axis of rotation of the tool spindle. The mechanical resistance element can have a longitudinal extension that is inclined or oriented perpendicular to an axis of rotation of the tool spindle.

The mechanical resistance element can have a freely projecting end section.

According to one design of the machine tool, it is provided that the mechanical resistance element is not a measuring probe, the mechanical resistance element is not a gear cutting tool and the mechanical resistance element is not a dressing tool.

The mechanical resistance element is therefore in particular not a measuring probe for tactile gear measurement in the sense of coordinate measuring technology and is not held on a measuring head for tactile gear measurement.

Furthermore, the mechanical resistance element is in particular not a gear cutting tool and does not have a geometrically defined or geometrically undefined cutting edge for machining the pre-toothed workpiece to be machined.

In particular, the mechanical resistance element is not a dressing tool and does not have a geometrically indeterminate cutting edge for dressing the gear cutting tool.

The machine tool is in particular a gear milling machine and is in particular not a gear grinding machine. In particular, the machine tool is set up for dry milling of pre-toothed workpieces and in particular has no coolant supply for the introduction of cooling lubricant. The machine tool can be a bevel gear hobbing machine, in particular for dry machining without coolant supply.

A control system of the machine tool can be set up to detect a mechanical resistance of the mechanical resistance element in engagement with the teeth of the pre-toothed workpiece.

In particular, the control system can be set up to evaluate a current consumption and/or a torque of a drive of the workpiece spindle, vibration sensors or the like. The mechanical resistance caused by the mechanical resistance element in the tooth engagement can be detected using one or more of the aforementioned signals and compared with a rotational position of the workpiece spindle in order to determine the position of the teeth and gaps.

According to the disclosure, a method is disclosed, wherein a machine tool according to the disclosure is used, comprising the method steps of finding tooth spaces and/or teeth of a pre-toothed workpiece held on a workpiece spindle of the machine tool, wherein the mechanical resistance element is brought into engagement with teeth of the pre-toothed workpiece.

In particular, the mechanical resistance element is successively brought into engagement with adjacent teeth, especially their tooth flanks.

The mechanical resistance created by the engagement, which opposes relative motion of the gear with respect to the mechanical resistance element, is measurable and can be correlated with a rotational or angular position of the workpiece spindle at the time of contact, for example, to determine the positions of the tooth spaces and teeth of the pre-toothed workpiece.

It may be provided that the pre-toothed workpiece is set in rotation by means of the workpiece spindle while the mechanical resistance element is engaged, wherein the mechanical resistance element is displaced by the teeth of the pre-toothed workpiece as a result of the rotation of the workpiece spindle and jumps from tooth space to tooth space or slides along the rotating teeth from tooth space to tooth space. This allows the mechanical resistance element to “rattle” through the tooth spaces of the pre-toothed workpiece.

At least one measured value for detecting the engagement or engagements of the mechanical resistance element can be recorded, wherein in particular a current consumption and/or a torque of a drive of the workpiece spindle, vibration sensors or the like are evaluated.

The engagement of the mechanical resistance element can be impulsive or jerky, in particular in the event that the mechanical resistance element slides along the respective tooth flanks under preload. The preload is released suddenly from tooth to tooth as the mechanical resistance element emerges from the positive fit in the direction of the next gap, wherein the end of the mechanical resistance element snapping towards the next adjacent tooth flank and slides along it.

Finding the tooth spaces and/or teeth can be a determination of the position of the tooth spaces and/or teeth in relation to the coordinate system of the machine tool, wherein the position of the tooth spaces is used for centering a gear cutting tool held on the tool spindle.

### BRIEF DESCRIPTION OF THE DRAWINGS

The disclosure is described in more detail below with reference to a drawing illustrating exemplary embodiments. The drawings schematically show in each case:

FIG. 1 shows a section of a gear cutting machine according to the disclosure, shown in a perspective view;

FIG. 2 shows the gear cutting machine from FIG. 1 in a front view;

FIG. 3 shows a bevel gear with a mechanical resistance element;

FIG. 4 shows a spur gear with a mechanical resistance element;

FIG. 5 shows measured values for recording the mechanical resistance; and

FIG. 6 shows method steps of a method according to the disclosure.

### DETAILED DESCRIPTION OF THE DRAWINGS

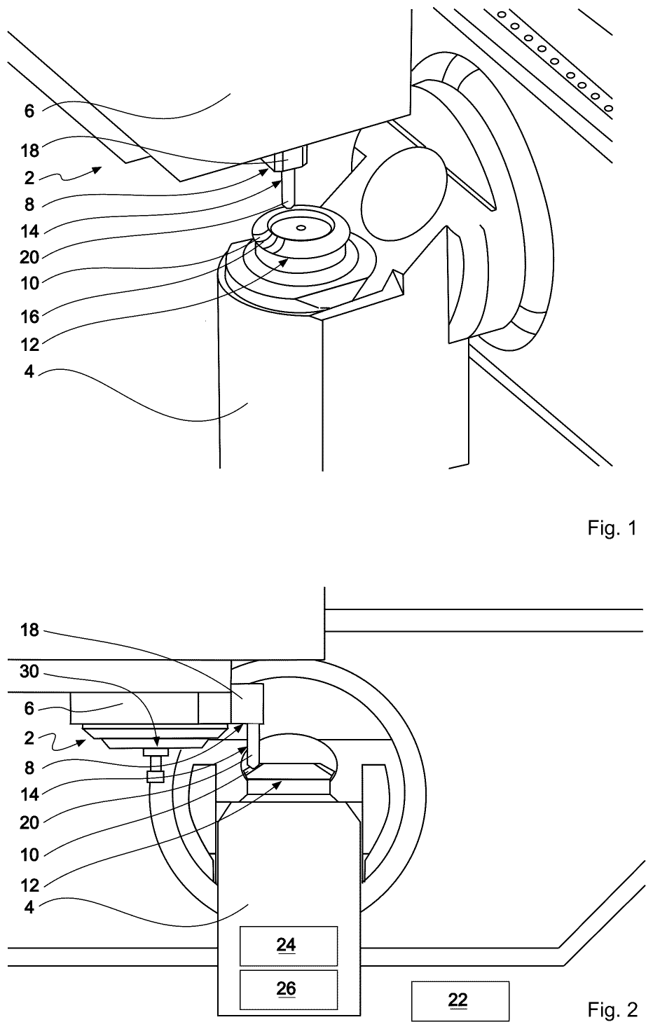

FIG. 1 shows a machine tool 2, which is a gear cutting machine for dry milling bevel gears.

The machine tool 2 has a workpiece spindle 4 and a tool spindle 6.

The machine tool 2 has a device 8 for finding tooth spaces 10 of a pre-toothed workpiece 12 held on the workpiece spindle 4.

The device 8 for finding tooth spaces 10 has a mechanical resistance element 14 for insertion into the tooth spaces 10 of the pre-toothed workpiece 12.

The mechanical resistance element is elastically deformable. Alternatively or additionally, the mechanical resistance element 14 can be resiliently preloaded in a contact position.

The mechanical resistance element 14 is set up to be displaced by teeth 16 of the pre-toothed workpiece 12, engaging in the tooth spaces 10 as a result of a rotation of the workpiece spindle 4, and to jump from tooth space 10 to tooth space 10. For the sake of clarity, only some gaps and teeth are shown schematically on the pre-toothed workpiece 12. It is understood that the pre-toothed workpiece 12 is fully toothed and has teeth and gaps over its entire circumference.

The mechanical resistance element 14 is held on the tool spindle 6 and can be moved with the controlled machine axes assigned to the tool spindle 14.

The mechanical resistance element 14 is attached to a carrier 18 associated with the tool spindle 6.

The mechanical resistance element 14 has a freely projecting end section 20.

The mechanical resistance element 14 is not a measuring probe, a gear cutting tool or a dressing tool.

A control system 22 of the machine tool 2 is set up to detect a mechanical resistance of the mechanical resistance element 14 in engagement with the teeth 16 of the pre-toothed workpiece 12. Here, for example, a current consumption and/or a torque of a drive 24 of the workpiece spindle 4, vibration sensors 26 or the like are evaluated.

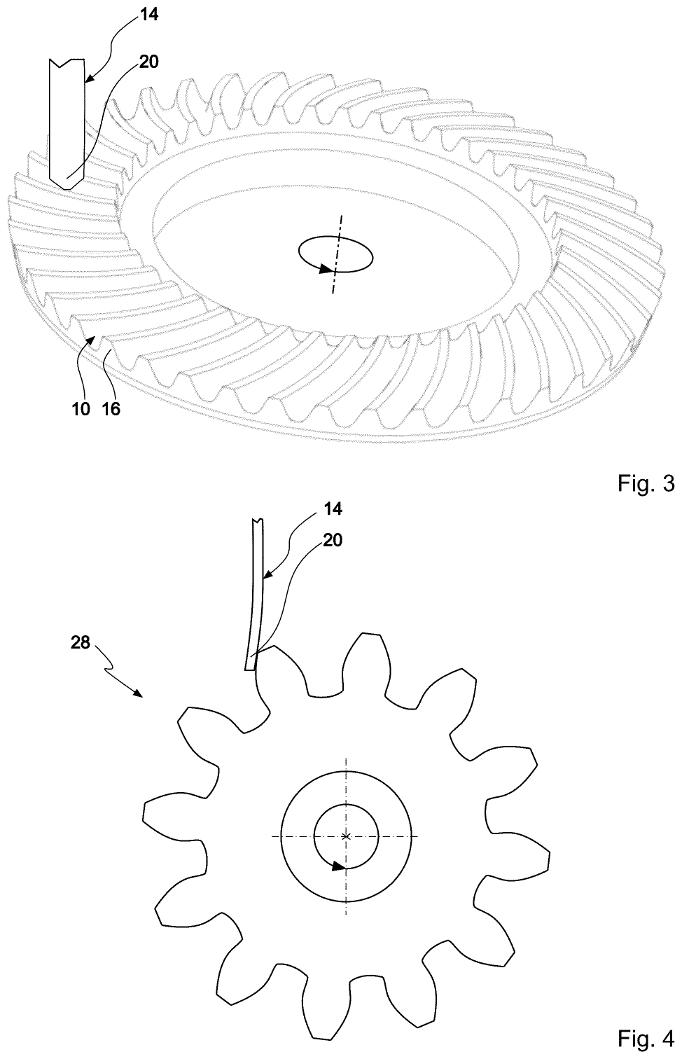

As can be seen in FIG. 3, the end section 20 of the mechanical resistance element 14 engages in the gaps 10 of the pre-toothed bevel gear blank 12 and jumps from gap to gap as a result of the rotation of the pre-toothed bevel gear blank 12 or is displaced in a sliding manner along the teeth 16.

FIG. 4 shows the displacement as an example and schematically for the example of a spur gear 28.

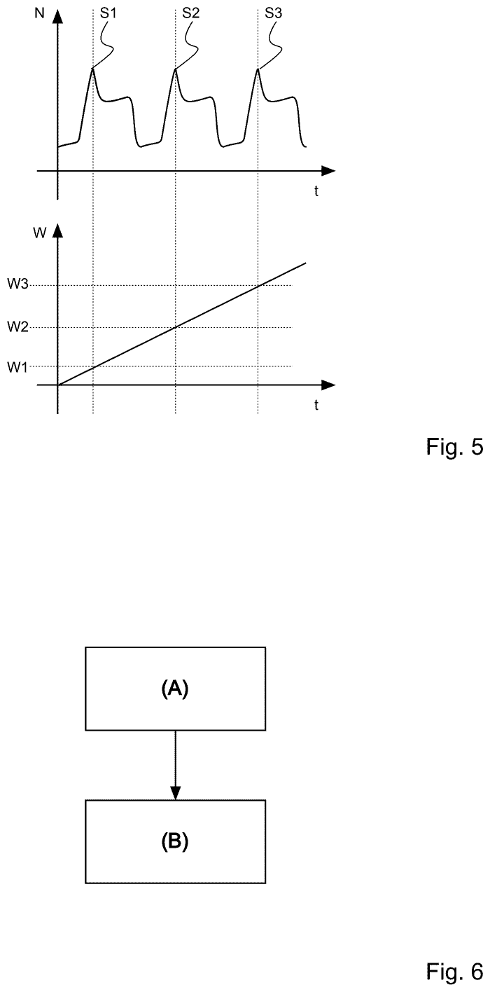

The resistance resulting from the engagement can be measured, for example, using a torque I of the drive 24, which is plotted over time t as an example in FIG. 5. Each meshing impact S1, S2, S3 is recognizable in the torque curve and can be correlated with a current angular position of the workpiece spindle in order to detect angular positions W1, W2, W3 of tooth flanks or teeth 16 and gaps 10.

A “rattling” of the mechanical resistance element 14 through all gaps 10 therefore allows the position of all teeth 16 within the be determined gear cutting machine 2 to in the clamped state on the workpiece spindle.

The mechanical resistance element 14 has a distance to the tool holder 30 of the tool spindle.

According to the disclosure, a method is disclosed, wherein the machine tool 2 is used, comprising the steps of: (A) finding tooth spaces of a pre-toothed workpiece held on a workpiece spindle of the machine tool, (B) wherein the mechanical resistance element is brought into engagement with teeth of the pre-toothed workpiece.

The pre-toothed workpiece 12 is set in rotation by means of the workpiece spindle 4 while the mechanical resistance element 14 is engaged, wherein the mechanical resistance element 14 is displaced by the teeth 16 of the pre-toothed workpiece 12 as a result of the rotation of the workpiece spindle 4 and jumps from tooth space 10 to tooth space 10.

Finding the tooth spaces 10 is a process of determining the position of the tooth spaces 10 in relation to a coordinate system of the machine tool 2, wherein the position of the tooth spaces is used to center a gear cutting tool (not shown) held on the tool spindle.

1. A machine tool for the production of gearings, the machine tool comprising:
a workpiece spindle,
a tool spindle and
a device for finding tooth spaces of a pre-toothed workpiece held on the workpiece spindle,
wherein
the device for finding tooth spaces has a mechanical resistance element configured for insertion into the tooth spaces of the pre-toothed workpiece.

2. The machine tool according to claim 1, wherein
the mechanical resistance element is elastically deformable and/or resiliently preloaded in a contact position,
wherein the mechanical resistance element is set up to be displaced by teeth of the pre-toothed workpiece, engaging in the tooth spaces as a result of a rotation of the workpiece spindle, and to jump from tooth space to tooth space.

3. The machine tool according to claim 1, wherein
the mechanical resistance element is held on the tool spindle and/or is movable with controlled machine axes assigned to the tool spindle,
wherein the mechanical resistance element is attached to a carrier assigned to the tool spindle.

4. The machine tool according to claim 1,
wherein the mechanical resistance element has a freely projecting end section.

5. The machine tool according to claim 1, wherein
the mechanical resistance element is not a measuring probe, the mechanical resistance element is not a gear cutting tool and the mechanical resistance element is not a dressing tool,
and/or
the machine tool is a gear milling machine and is not a gear grinding machine.

6. The machine tool according to claim 1,
wherein
a control system of the machine tool is set up to detect a mechanical resistance of the mechanical resistance element in engagement with the teeth of the pre-toothed workpiece, wherein
a current consumption and/or a torque of a drive of the workpiece spindle, vibration sensors are evaluated.

7. A method using the machine tool according to claim 1, the method including the following steps:
finding tooth spaces and/or teeth of a pre-toothed workpiece held on a workpiece spindle of the machine tool, wherein
the mechanical resistance element is brought into engagement with teeth of the pre-toothed workpiece.

8. The method according to claim 7,
wherein the pre-toothed workpiece is set in rotation by the workpiece spindle while the mechanical resistance element is engaged, wherein the mechanical resistance element is displaced by the teeth of the pre-toothed workpiece as a result of the rotation of the workpiece spindle and jumps from tooth space to tooth space.

9. The method according to claim 7,
wherein at least one measured value for detecting the engagement is recorded, wherein a current consumption and/or a torque of a drive of the workpiece spindle, vibration sensors are evaluated.

10. The method according to claim 7, wherein the finding of the tooth spaces and/or teeth is a determination of the position of the tooth spaces and/or teeth in relation to the coordinate system of the machine tool, wherein the position of the tooth spaces and/or teeth is used for centering a gear cutting tool held on the tool spindle.
